(19) United States
(12) Patent Application Publication
(10) Pub. No.: US 2012/0122501 A1
(43) Pub. Date: May 17, 2012

(54) WIRELESS COMMUNICATION SYSTEM AND DEVICE THEREOF

(75) Inventor: Chung-Chiu Lai, Hsinchu County (TW)

(73) Assignee: GEMTEK TECHNOLOGY CO., LTD., Hsinchu (TW)

(21) Appl. No.: 13/166,833

(22) Filed: Jun. 23, 2011

(30) Foreign Application Priority Data
Nov. 11, 2010 (TW) 99138880

(51) Int. Cl. H04W 56/00; H04W 72/02

(52) U.S. Cl. 455/500

(57) ABSTRACT

A wireless communication system and a wireless communication device thereof are proposed. The system is adapted for synchronizing wireless setting of at least a wireless communication device in the system. The at least a wireless communication device synchronizes a first wireless setting thereof or synchronizes a second wireless setting of another wireless communication device in the system by just wireless network signal. Moreover, the at least a wireless communication device determines whether the first wireless setting thereof is the latest by checking a sequence number in the wireless network signal.

### CROSS-REFERENCE TO RELATED APPLICATION

This application claims the priority benefit of Taiwan application serial no. 99138880, filed Nov. 11, 2010. The entirety of the above-mentioned patent application is hereby incorporated by reference herein and made a part of this specification.

### BACKGROUND

1. Technical Field

The invention generally relates to a synchronization mechanism of wireless network settings, and more particularly, a wireless communication system and a wireless communication device thereof which merely uses wireless signal to realize synchronization of wireless network settings.

2. Related Art

When a plurality of wireless network equipments are installed in a wireless communication network, current configuration processes involved with the installation consumes a lot of time since each one of the wireless network equipments is required to configured with identical wireless network settings. Thus, there are technologies being developed such as cluster technology, control and provisioning of wireless access points (CAPWAP) mechanism, such that configuration processes can be simplified for the wireless network equipments can have its own wireless network setting synchronized once the wireless network equipments are boot up. When any one of the wireless network equipments is updated, other wireless network equipments can also be synchronized to the update settings of the wireless network equipments, in order to reduce configuration time of wireless network administrators. For the synchronization configuration in the wireless communication network, the cluster technology still needs to be implemented through a fixed line local area network. The CAPWAP mechanism needs a wireless local area network or the fixed line local area network to realize the synchronization configuration in the wireless communication network. Alternatively, Wi-Fi protected setup (WPS) can also be used to synchronize each one of the wireless network equipment in the wireless communication network.

However, the aforementioned synchronization approaches can be applied for configuring the wireless network equipments which do not have any fixed line local area network port, such as a wireless bridge, a wireless repeater, or wireless equipments in a meshed network as defined in IEEE 802.11S standard. Therefore, it is a major concern that how to efficiently synchronizing wireless network settings of wireless network equipments in a wireless communication network.

### SUMMARY

Accordingly, the invention provides a wireless communication system and a wireless communication device thereof, which uses wireless network signal and a distributed strategy or a diffusion strategy to realize synchronization of wireless network settings of each one of wireless communication devices in a wireless communication network.

In consistent with an exemplary embodiment of the invention, the invention proposes a wireless communication system, adapted for synchronizing wireless network settings of at least a wireless communication device in the wireless communication system, and the wireless communication system includes at least a wireless communication device. The wireless communication device synchronizes first wireless network setting thereof by merely at least wireless network signal, or synchronizing second wireless network setting of another wireless communication device by the at least wireless network signal. In addition, the wireless communication device determines whether the first wireless network setting is the latest by checking a sequence number in the at least wireless network signal from other wireless communication devices.

In consistent with an exemplary embodiment of the invention, the invention proposes a wireless communication device, adapted for d synchronizing wireless network settings thereof. The wireless communication device includes a wireless communication protocol stack module and a determination module. The wireless communication protocol stack module synchronizes first wireless network setting thereof by merely at least wireless network signal, or synchronizes second wireless network setting of another wireless communication device by the at least wireless network signal. In addition, the determination module is coupled to the wireless communication protocol stack module, and determines whether the first wireless network setting is the latest by checking a sequence number in the at least wireless network signal from other wireless communication devices.

In view of the aforementioned disclosure, embodiments of the invention propose a wireless communication system and a wireless communication device, which synchronizes wireless network settings. Wireless network settings of each one of wireless communication devices in the wireless communication system are synchronized by merely wireless network signal. Whether there is a new wireless network setting is determined by checking sequence number in the wireless network signals. Accordingly, wireless network settings can be synchronized in a distributed manner by using merely wireless network signal but without any wired network.

It is to be understood that both the foregoing general description and the following detailed description are exemplary, and are further intended to provide the explanation of the present disclosure as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and serve to explain the principles of the invention together with the description.

FIG. 1 is a schematic diagram illustrating a wireless local area network system.

FIG. 2 is a functional block diagram of a wireless communication device according to an exemplary embodiment of the invention.

FIG. 3A is a schematic structure diagram illustrating a wireless network beacon according to an exemplary embodiment of the invention.

FIG. 3B is a schematic structure diagram illustrating a vendor specific content according to an exemplary embodiment of the invention.

FIG. 4 is a flowchart illustrating a method for updating wireless network settings according to an exemplary embodiment of the invention.

FIG. 5 is a flowchart illustrating a method for synchronizing wireless network settings according to the first exemplary embodiment of the invention.

FIG. 6 is a schematic structure diagram illustrating a wireless action frame.

FIG. 7 is a flowchart illustrating another method for updating wireless network settings according to an exemplary embodiment of the invention.

FIG. 8 is a flowchart illustrating another method for synchronizing wireless network settings according to an exemplary embodiment of the invention.

FIG. 9 is a flowchart illustrating a method for synchronizing wireless network settings according to an exemplary embodiment of the invention.

FIG. 10 is a flowchart illustrating a method for synchronizing wireless network settings according to an exemplary embodiment of the invention.

### DESCRIPTION OF THE EXEMPLARY EMBODIMENTS

Reference will now be made in detail to the exemplary embodiments of the invention, examples of which are illustrated in the accompanying drawings. Wherever possible, the same reference numbers are used in the drawings and the description to refer to the same or like parts.

The invention provides a wireless communication system and a wireless communication device thereof, which is adapted for methods for synchronizing wireless network settings. The methods for synchronizing wireless network settings generally use wireless network signal and a distributed strategy (or a diffusion strategy) to realize synchronization of wireless network settings of each one of wireless communication devices in a wireless communication network.

The operational principle of the proposed methods for synchronizing wireless network settings, basically merely uses wireless communication technology to connect wireless network equipments, but does not require using wired network connection to connect wireless network equipments. The proposed methods for synchronizing wireless network settings uses wireless network signal, such as wireless network beacon, into which a message is added for notifying nearby wireless communication devices that currently the wireless network setting value is updated, and the nearby wireless communication devices can be, for example, wireless network access point device. Alternatively, wireless network settings of the nearby wireless communication devices can be obtained in order to confirm or check whether the current configuration status is synchronized. If there is discovered a wireless communication device whose wireless network setting is not synchronized (i.e., not updated), then the wireless network setting can be synchronized by following at least three synchronization methods.

The first method for synchronizing wireless network setting is to put all of wireless network setting values in a wireless network beacon, and when any one of the wireless communication devices find its own wireless communication setting is not synchronized, the wireless communication device can obtain the updated wireless network setting from the wireless network beacon, and have its own wireless communication setting synchronized to the updated wireless network setting.

The second method for synchronizing wireless network setting is to listen to wireless network beacons broadcasted from other wireless communication devices, in order to determine whether wireless network setting values of other wireless communication devices are updated. In addition, a vendor-specific action frame as defined in chapter 7.4.5 of IEEE 802.11 specification can be used for delivering wireless network setting to the wireless communication device whose wireless network settings are not yet update.

The third method for synchronizing wireless network setting is modified from the aforementioned second method. The third method for synchronizing wireless network setting is involved with a first wireless communication device detecting nearby wireless communication beacons. When the first wireless communication device detects new wireless network setting, the first wireless communication device immediately transmits request signal to a second wireless communication device whose wireless network setting is updated, so as to request the second wireless communication device to transmit a vendor-specific action frame for updating the wireless network setting of the first wireless communication device.

Moreover, the wireless network setting in the invention can be, for example, service set identifier (SSID), security related configuration, add/remove access control list (add/remove ACL), Wi-Fi multimedia (WMM) and so forth. In the invention, wireless network setting is delivered by using existing IEEE 802.11 mechanism, so as to update all of wireless communication devices in a wireless communication network. The wireless communication network can be a campus network, or an enterprise network. The invention mainly operates in an application in order to completely cover an area. The method for synchronizing wireless network setting and wireless communication devices using the same methods can support meshed network compatible with IEEE 802.11S standard, and can be applied to wireless bridges and wireless repeaters which doe not have wired network ports.

Furthermore, the method for synchronizing wireless network setting can also uses a plurality of wireless network signal with short duration, smaller size wireless network frames, or smaller size wireless network packets to deliver updated wireless network settings, so as to avoid the synchronization process of wireless network setting reduce overall system transmission performance of a wireless communication network. The method for synchronizing wireless network setting can device wireless network setting values into a plurality of portions, and each one of the divided portions can be delivered with smaller frame sizes or shorter signal durations, so as to avoid the synchronization process lower the overall transmission performance.

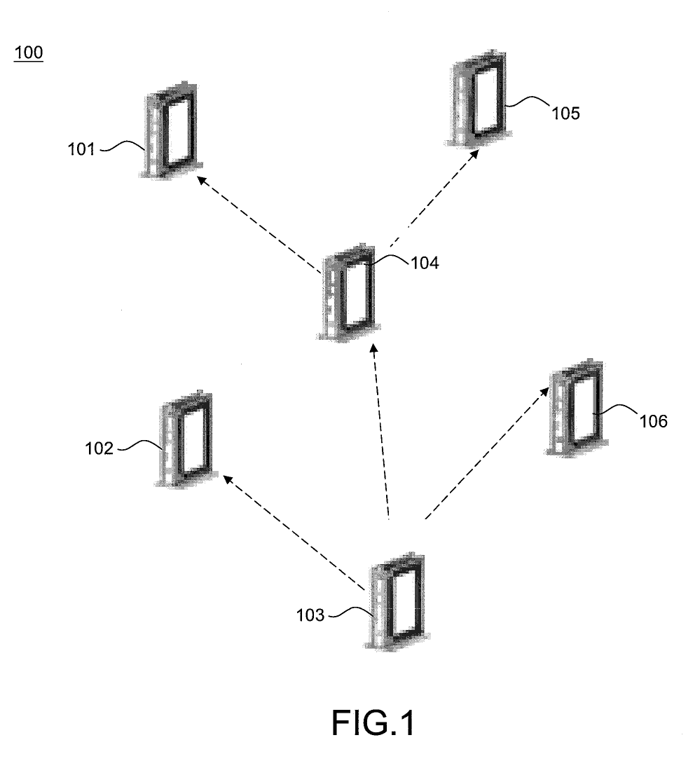

FIG. 1 is a schematic diagram illustrating a wireless local area network system 100. Referring to FIG. 1, the wireless local area network system 100 includes a plurality of wireless communication devices 101, 102, 103, 104, 105, 106 and so forth. Some of the wireless communication devices 101-106 are wireless access points (AP), while the rest of the wireless communication devices can be wireless bridges or wireless repeaters. Moreover, some of the wireless communication devices 101-106 are not connected ay wired communication network. However, the invention is not limited to the aforementioned disclosure, and the proposed method for synchronizing wireless network setting in the invention can be still adapted for a wireless local area network which is formed by all wireless APs, or can be applied to wireless communication devices which are all connected by wired communication networks.

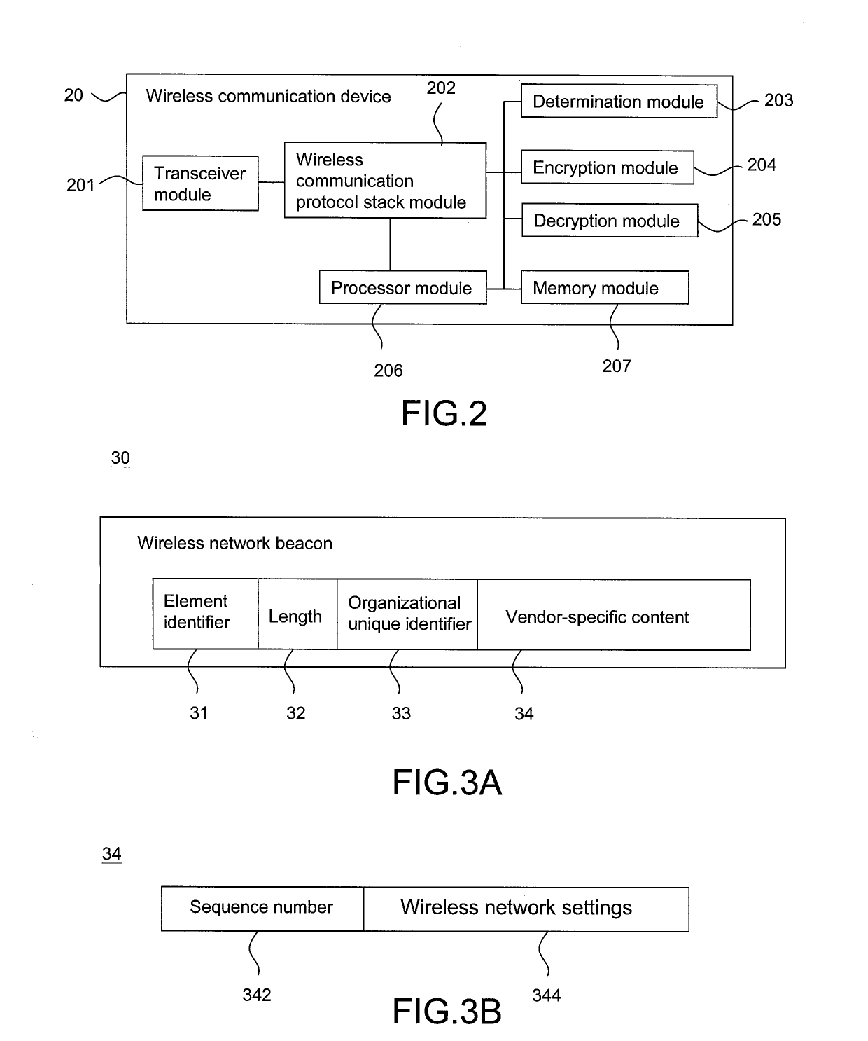

Furthermore, each one of the wireless communication devices 101-106 support auto channel selection functionality. The channels respectively used by the wireless communication devices 101-106 are described as following: the wireless communication device 101 uses a channel 1 (Ch1); the wireless communication device 102 uses a channel 6 (Ch6); the wireless communication device 103 uses a channel 11 (Ch11); the wireless communication device 104 uses a channel 11 (Ch11); the wireless communication device 105 uses a channel 6 (Ch6); the wireless communication device 106 uses a channel 1 (Ch1). Before the method for synchronizing wireless network setting is introduced in details, a functional block diagram of any one of the wireless communication devices 101-106 is introduced in accordance with FIG. 2. In addition, a method for synchronizing wireless network setting is introduced in accordance with FIG. 3A and FIG. 3B.

FIG. 2 is a functional block diagram of a wireless communication device 20 according to an exemplary embodiment of the invention. Referring to FIG. 2, the wireless communication device 20 can be a wireless AP, a wireless gateway, a wireless bridge or a wireless repeater. The wireless communication device 20 includes a transceiver module 201, a wireless communication protocol stack module 202, a determination module 203, an encryption module 204, a decryption module 205, a processor module 206 and a memory module 207.

In the present embodiment, the transceiver module 201 is coupled to an antenna module (not shown), and is configured for transmitting and receiving radio frequency (RF) signals. The wireless communication protocol stack module 202 is coupled to the transceiver module 201, and is configured for processing wireless communication protocols and wireless signal related to wireless communication network. The wireless communication protocols include IEEE 802.11a/b/g/n standard. The determination module 203 is coupled to the wireless communication protocol stack module 202, and is configured for receiving wireless network signal, wireless network beacons received or wireless network frames by the wireless communication protocol stack module 202. The determination module 203 further compares sequence number of the wireless network signal, the wireless network beacons or the wireless network frames with the sequence number stored in the wireless communication device 20, and determines whether the wireless network setting values are newer or older according to the comparison result.

The encryption module 204 is coupled to the wireless communication protocol stack module 202, and is configured for encrypting wireless network setting to be transmitted in wireless network signal, wireless network beacons or wireless network frames. The decryption module 205 is coupled to the wireless communication protocol stack module 202, and is configured for decrypting wireless network setting in the received wireless network signal, the received wireless network beacons or the received wireless network frames. The encryption/decryption methods used by the encryption module 204 and the decryption module 205 can be, for example, triple data encryption algorithm (3DES) or using a certification Hash to realize the encryption/decryption process. The memory module 207 is coupled to the wireless communication protocol stack module 202 and the determination module 204, and is configured for recording at least a sequence number of the wireless communication device 20, and recording sequence number(s) in the wireless network signal, the received wireless network beacons or the received wireless network frames.

The processor module 206 is coupled to the transceiver module 201, the wireless communication protocol stack module 202, the determination module 203, the encryption module 204, the decryption module 205, and the memory module 207. Moreover, in the aforementioned embodiments, the wireless communication protocol stack module 202, the determination module 203, the encryption module 204, and the decryption module 205 can be hardware modules or hardware units, which store its own software programs or firmware programs. In other embodiments of the invention, the wireless communication protocol stack module 202, the determination module 203, the encryption module 204, the decryption module 205, and the memory module 207 can also be software modules or software units, and stored in the memory module 207. The processor module 206 is configured to execute these software modules or software units.

FIG. 3A is a schematic structure diagram illustrating a wireless network beacon 30 according to an exemplary embodiment of the invention. In the invention, the wireless network beacon 30 is just used for illustration, and can be replaced by wireless network packets, wireless network signal or wireless network frames. The wireless network beacon 30 can include an element identifier (ID) 31, a length field 32, an organizational unique identifier (OUI) 33 and a vendor-specific content 34.

According to chapter 7.3.2.26 in IEEE 802.11 specification, the element ID 31 has a size of 8 bits (equivalent to 1 byte); the length field 32 has a size of 1 byte; OUI 33 has a length of 3 bytes; the vendor-specific content 34 has wireless network setting of at least 256 bytes. The aforementioned element ID 31 and the length field 32 can be referred to IEEE 802.11 specification, so the technical content thereof are not described in details here. The OUI 33 can be used as a feature (characteristic) value, which can include the feature value of, for example, 0x123456. Thus the wireless communication device which receives the wireless network beacon 30 can know that the wireless network beacon 30 is used for synchronizing wireless network settings. The vendor-specific content 34 of the wireless network beacon 30 is introduced in accordance with FIG. 3B.

FIG. 3B is a schematic structure diagram illustrating a vendor-specific content 34 according to an exemplary embodiment of the invention. FIG. 3B illustrates a format of the vendor-specific content 34. Referring to FIG. 3B, the vendor-specific content 34 includes a sequence number field 342 and a wireless network setting 344. The sequence number 342 has a length of 1 byte, and is used for representing a version number of the wireless network setting 344 of the current vendor-specific content 34. Thus, the wireless communication device which receives the wireless network beacon 30 can determine whether the corresponding wireless network setting 344 is newer, updated, not updated, or older. The wireless network setting 344 can be a series of encrypted information, and the encryption method used can be, for example, 3DES method, or using certificate Hash to realize the encryption process.

In the present embodiment, suppose a wireless communication device, such as a wireless repeater is not yet configured. Therefore, the sequence number 342 of the vendor-specific content 34 in the wireless network beacon 30 broadcasted by this wireless communication device is 0. That is, the sequence number field 342 contains a pre-configured value of 0x000000. When the network administrator continues to update the wireless network setting of the wireless communication device, then the sequence number 342 is incremented by 1 unit by the wireless communication device every time the wireless setting is updated. Moreover, the memory module 207 is also configured for recording the current content of the sequence number 342, so as to help determining whether the current sequence number of the wireless communication device is the latest when receiving wireless network beacons of other wireless communication devices. However, the invention is not limited thereto, and in other embodiments of the invention, a version number, time information or any other string, which can be used for determining the temporal order, can be used as the content of the sequence number 342. The updating principle of the sequence number can be adapted for each one of following embodiments.

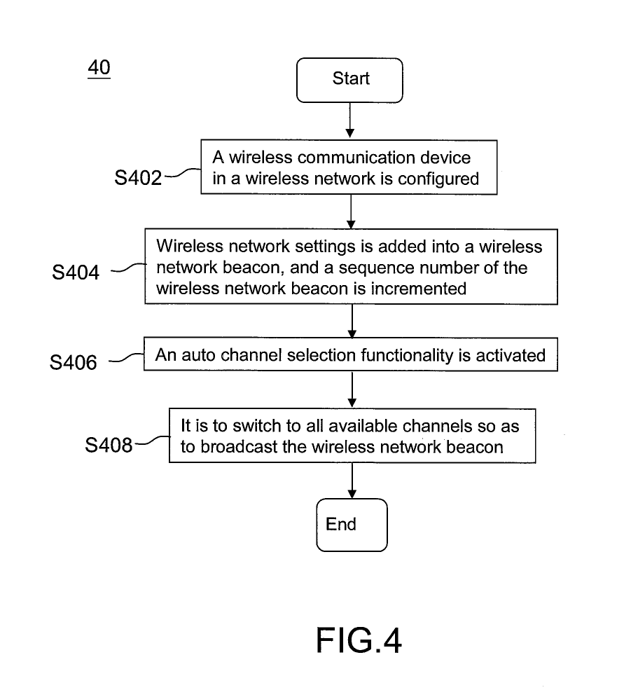

FIG. 4 is a flowchart illustrating an updating wireless network settings method 40 according to an exemplary embodiment of the invention. Referring to FIG. 2, FIG. 3B and FIG. 4, the updating wireless network settings method 40 starts at step S402. The network administrator configures a wireless communication device (e.g., a wireless communication device 103) in a wireless communication network (step S402). The wireless communication protocol stack module 202 adds the wireless network setting 344 into the wireless network beacon 30 of the configured wireless communication device 103, and increments the sequence number 342 by 1 unit (step S404). However, as described previously, in other embodiments of the invention, a version number, time information or any other string, which can be used for determining the temporal order, can be used as the content of the sequence number 342. Furthermore, the encryption module 204 performs encryption process on the wireless network setting configured by the network administrator before the wireless network setting is added into the wireless network beacon 30, so as to avoid equipments or personnel, which are not belonging to this wireless communication network, acquire the configured wireless network setting.

Referring to FIG. 4, the wireless communication protocol stack module 202 of the configured wireless communication device 103 activates auto channel selection functionality (step S406). For example, in the operation mode of IEEE 802.11b/g, the wireless communication device 103 can gradually switch from the channel 1 (Ch1) to the channel 11 (Ch 11). However, since the available channel in every country is not identical, the updating wireless network setting method or the synchronizing wireless network setting method in embodiments of the invention has to gradually switch between available channels according to the channels available to every country. The wireless communication protocol stack module 202 of the configured wireless communication device 103 gradually switch to all available channels, so as to broadcast the wireless network beacon 30 (step S408), in order to notify the wireless communication device which is currently using the channel that the wireless network setting is modified.

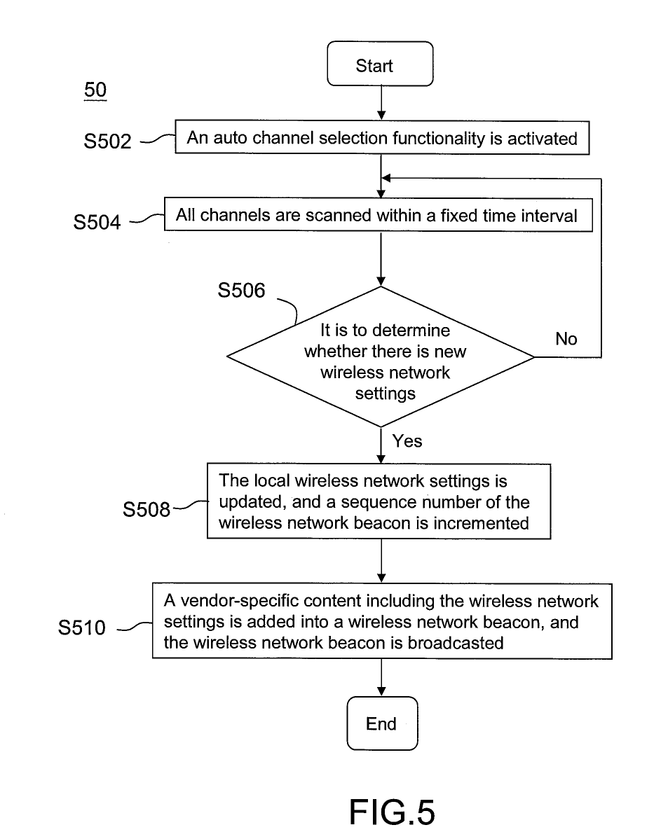

Moreover, in the step S408, the wireless communication device 103 can stay in each one of the available channels for a pre-determined time interval, and continually broadcast the wireless network beacon 30, such that the nearby wireless communication devices have sufficient time to process the wireless network beacon 30, and subsequent comparison, determination, and updating the wireless network setting or any other related processing. The pre-determined time interval for staying in each one of the available channels can be, for example, 500 milliseconds (ms). The updating wireless network settings method 40 is terminated after the step S408. In practical operations, the step S402 to the step S408 can be repeatedly operated, so as to continually update the wireless network settings for meeting requirements of practical operations. After the updating wireless network settings method 40 is introduced, a corresponding method for synchronizing wireless network settings is introduced below in accordance with FIG. 5.

FIG. 5 is a flowchart illustrating a synchronizing wireless network settings method 50 according to the first exemplary embodiment of the invention. Referring to FIG. 2, FIG. 3B and FIG. 5, the synchronizing wireless network settings method 50 belongs to a first type of synchronization method, and starts at step S502. In a wireless communication system (such as the wireless local area network system 100), the wireless communication protocol stack module 202 of each one of the wireless communication devices activates its own auto channel selection functionality (step S502). The wireless communication protocol stack module 202 of each one of the wireless communication devices scans all channels or all available channels within a fixed time interval (step S504), and the fixed time interval can be, for example, 1 minute. The determination module 203 of each one of the wireless communication devices determines whether there is new wireless network setting (step S506). If it is determined that there is new wireless network setting, then after the step S506, step S508 is executed; if it is determined that there is no new wireless network setting, then after the step S506, the step S504 is repeated.

The determination procedure in the step S506 is to check whether its own first sequence number is less than a second sequence number in a received wireless network beacon. It the first sequence number is less than the second sequence number, it means the received wireless network beacon contains newer or updated wireless network setting. Meanwhile, it also represents that the wireless communication device corresponding to the received wireless network beacon is updated or has newer wireless network setting.

Referring to FIG. 5, since the determination module 203 determines that the first sequence number of its own is less than the second sequence number of the received wireless network beacon, it means that there is newer or more updated wireless network setting. The wireless communication protocol stack module 202 of the wireless communication device which receives the wireless network beacon updates its own wireless network setting as well as increment its first sequence number (step S508). To be illustrated more clearly, in the step S508, the decryption module 205 of the wireless communication device which receives the wireless network beacon decrypts and decodes the wireless network setting 344 in the received wireless network beacon 30. A newer or more updated second wireless network setting is acquired by the wireless communication protocol stack module 202 of the wireless communication device, and the wireless communication protocol stack module 202 further updates the newer or more updated second wireless network setting into the memory module 207 or into the wireless communication protocol stack module 202. That is, a first wireless network setting originally stored in the memory module 207 or in the wireless communication protocol stack module 202 is updated to be identical to the content of the second wireless network setting.

Furthermore, the wireless communication protocol stack module 202 of the wireless communication device puts the second wireless network setting into a wireless network beacon of its own, and broadcast the wireless network beacon (S510). The synchronizing wireless network settings method 50 is terminated after the step S510. In practical operations, the step S504 to the step S510 can be repeatedly operated, so as to continually synchronize the wireless network settings for meeting requirements of practical operations. It is noted that the wireless network beacon 30 is just for the purpose of illustration. In other embodiments of the invention, wireless network packets, wireless network signal or wireless network frames can also be used to broadcast the OUI 33, the sequence number field 342 and the wireless network setting 344, so as to realize the synchronizing wireless network settings method 50.

The step S510 can assist each one of the wireless communication devices whose wireless network settings are updated to continue configuring or updating nearby wireless communication devices until the wireless network settings of wireless communication devices completely covered by the wireless network system are updated. That is, wireless network setting of each one of the wireless communication devices in the wireless network system is synchronized. The wireless communication devices here can be referred to wireless repeaters, wireless bridges, wireless gateways, or wireless relays.

The aforementioned configuration approach can be illustrated as a dashed arrow in FIG. 1, in which the wireless communication device 103 update or configure the wireless communication devices 102, 104, 106 in a distributed manner. The wireless communication device 101 can be further updated or configured by the wireless communication device 104 (or the wireless communication device 102, 106). Alternatively, the aforementioned configuration approach is summarized as following. Through each one of the wireless communication devices repeatedly executing the step S504 to the step S510 according to a wireless network topology of the wireless communication network system in which the wireless communication devices are located, the wireless network setting of each one of the wireless communication devices can be updated or synchronized. Also, the aforementioned methods for synchronizing wireless network settings in a distributed or diffusion manner can also be applied to each one of following embodiments.

Although the synchronizing wireless network settings method 50 can individually use wireless network beacons, wireless network packets, wireless network signal or wireless network frames and does not need the wired network to realize synchronization of the wireless network setting of each one of wireless communication devices, it is not the best approach to just use the wireless network beacon 30 for synchronizing the wireless network settings.

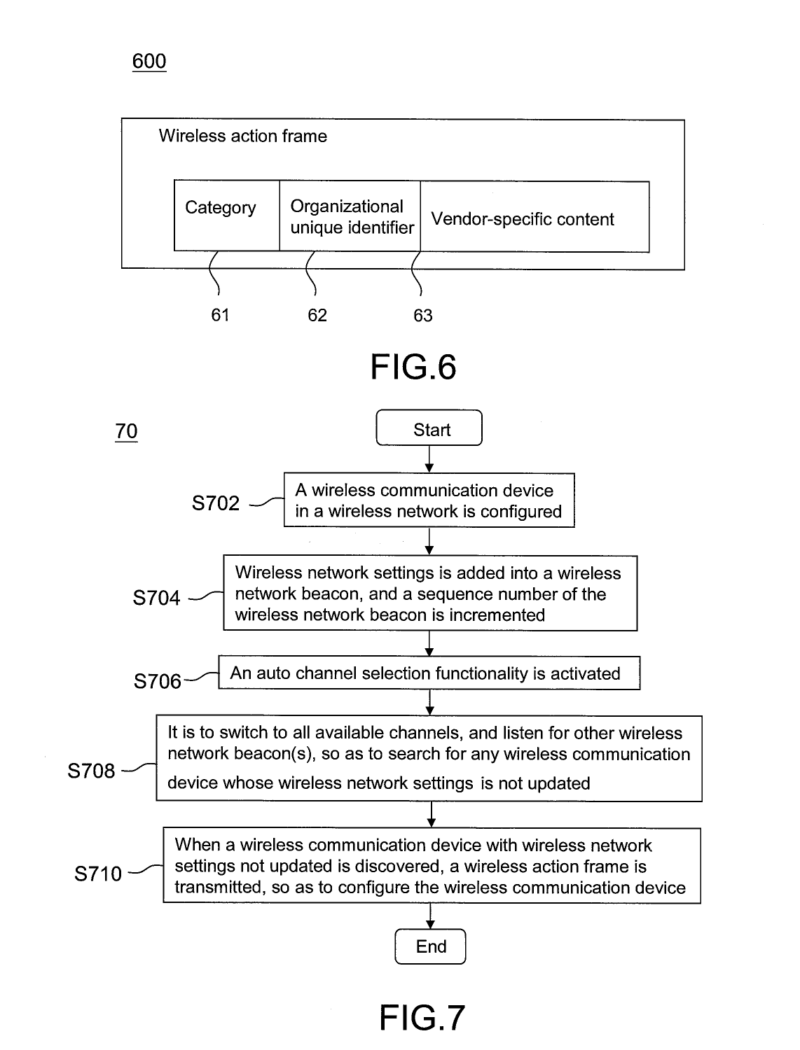

It is due to the fact that the length of the wireless network beacon 30 is at least 255 bytes, and the wireless network beacon 30 is required to be broadcasted at a lowest transmission rate (e.g., 1 Mbps in IEEE 802.11g mode). Also, IEEE 802.11 system adopts carrier sense multiple access with collision detection (CSMA/CD), so when one of the wireless communication devices occupies a channel for transmitting any wireless signal, wireless network beacon, wireless network frame, or wireless network packet, other wireless communication devices in the same wireless communication network can not use the occupied channel. Therefore, when the length of the wireless network beacon 30 is too long, it easily cause an overall transmission efficiency become low. Other updating wireless network setting methods and synchronizing wireless network setting methods, which can prevent the overall transmission efficiency from being lowered, are introduced in accordance with FIG. 6 to FIG. 10.

FIG. 6 is a schematic structure diagram illustrating a wireless action frame 60. As illustrated in FIG. 6, the wireless action frame 60 includes a category field 61, an organizational unique identifier (OUI) 62, and a vendor-specific content field 63. The category field 61 and the OUI field 62 are respectively 1 byte long and 3 bytes long. The category field 61 and the OUI field 62 can be referred to chapter 7.4.5 of IEEE 802.11 specification, so the technical content thereof are not repeated in details. The vendor-specific content field 63 can include a wireless network setting, and the format of the vendor-specific content field 63 is that the length of the vendor-specific content field 63 is within 252 bytes. Similar to the description of FIG. 3B, the OUI field 62 in each one of the following embodiments can also be used as a feature (characteristic) value of the wireless action frame for updating or synchronizing the wireless network setting, and the feature value can have a content of 0x123456. That is, when a wireless communication device receives the wireless action frame 60, the receiving wireless communication device can determine the frame is used for updating or synchronizing the wireless network setting by determining the wireless action frame 60 includes the OUI 62 and the content of the OUI 62 is 0x123456.

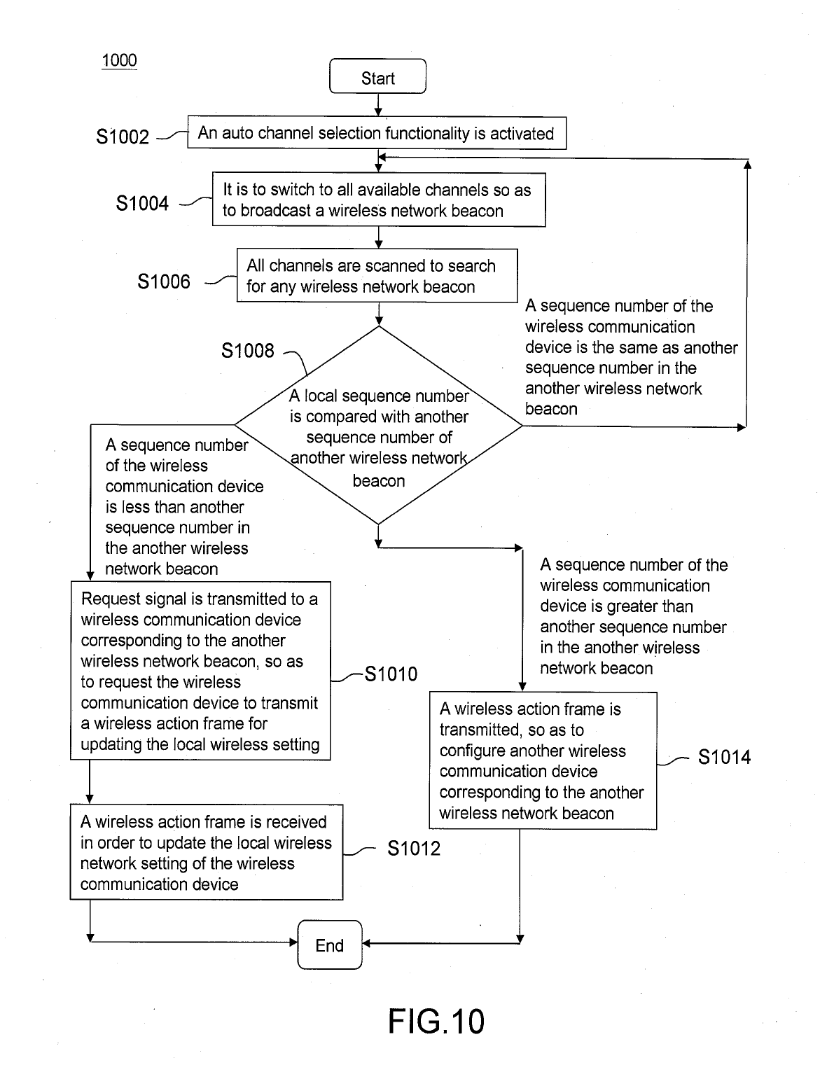

In each one of the embodiments of FIG. 6 and FIG. 10, the wireless network beacon (not shown) just includes an element ID field 31, a length field 32, an organizational unique identifier 33 and a sequence number 342, but does not include the wireless network setting 344. If it is required to update or synchronize the wireless network settings of any wireless communication device, then the wireless action frame 60 is transmitted to realize updating or synchronizing the wireless network setting.

Since the receiving end of the wireless action frame 60 is specific, the wireless communication device at the transmitting end can transmit the wireless action frame 60 at normal transmission rate (not the lowest transmission rate) for updating or synchronizing the wireless network setting, but does not need to transmit the wireless action frame 60 at the lowest transmission rate. Also, if the amount of data of the wireless network setting is too much, then the wireless network setting can be divided into a plurality of portions. Then, one wireless action frame 60 or a plurality of wireless action frames 60 can be used to successively transmit the divided wireless network setting. Accordingly, the length of the wireless network beacon is greatly reduced, and the overall transmission efficiency of the wireless communication system is prevented from being lowered due to the procedure of synchronizing the wireless network setting.

Meanwhile, compared to the updating method or the synchronization method illustrated in FIG. 4 and FIG. 5 just supporting the wireless network setting whose whole size is limited to 255 bytes, the updating or synchronizing wireless network setting by the wireless action frame 60 can be extended to support the wireless network settings which is greater than (or much greater than) 255 bytes, since the divided wireless network setting can be successively transmitted by more than one wireless action frame 60. The approach of successively transmitting the divided wireless network setting can also be applied to the wireless communication network system similar to FIG. 1.

FIG. 7 is a flowchart illustrating another method updating wireless network settings according to an exemplary embodiment of the invention. Referring to FIG. 1, FIG. 4 and FIG. 6, and the updating wireless network setting method 70 starts at step S702. The step S702 and step S706 are respectively similar to the step S402 and the step S406, so the technical content thereof are not repeated herein. In the step S704, in the wireless action frame 60 of the configured wireless communication device (such as the wireless communication device 103 in FIG. 1), an updated wireless network setting is added into the vendor-specific content field 63, and the sequence number thereof is also incremented. The latest sequence number is simultaneously added into the wireless network beacon, and also recorded in the memory module 207 of the configured wireless communication device.

In step S708, the configured wireless communication device 103 can stay for a period in each one of the available channels, and continue to listen to or receive wireless network beacon(s), such that the configured wireless communication device 103 is enabled with sufficient time to receive any wireless network beacon and perform subsequent comparison and determination, and further transmit the wireless action frame 60 for updating configuration value of nearby wireless communication devices. The duration for staying in each one of the available channels can be, for example, 500 ms.

In step S710, when the determination module 203 of the configured wireless communication device 103 finds any wireless communication device whose wireless network setting is not yet updated after comparing a first sequence number thereof and a second sequence number of the received wireless network beacon, then a wireless action frame 60 is transmitted for configuring the wireless communication device (such as the wireless communication device 104 in FIG. 1) whose wireless network setting is not updated. If the result of the comparison process is the first sequence number is greater than the second sequence number, then it represents that the configured wireless communication device 103 has a newer (or more updated) first wireless network setting, as compared with a second wireless network setting of another wireless communication device corresponding to the received wireless network beacon.

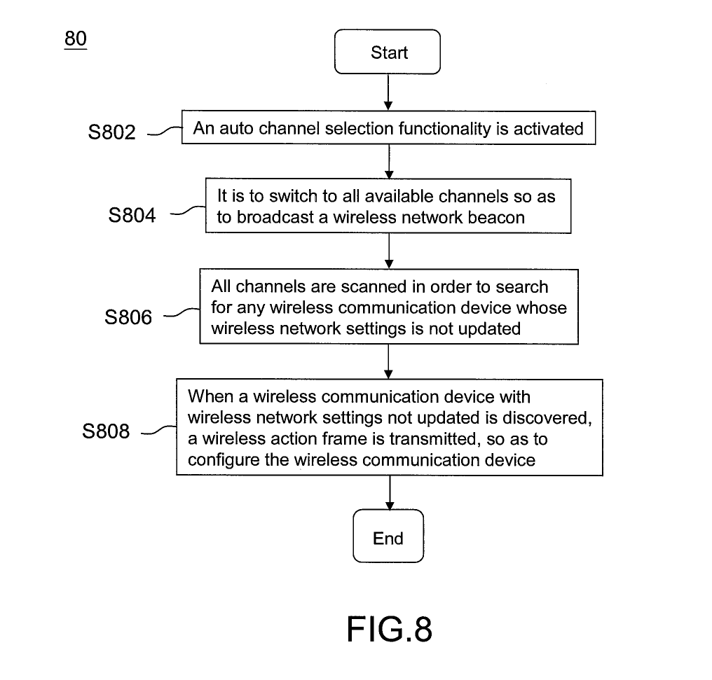

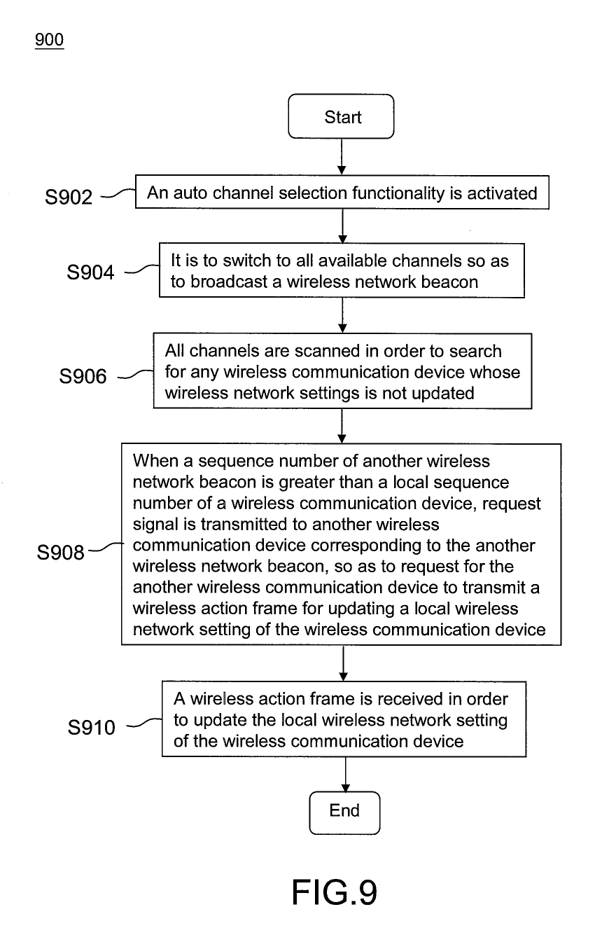

The updating wireless network setting method 70 is terminated after the step S710. In practical operations, the step S702 to the step S710 can be repeatedly executed for continually updating the wireless network settings. After the updating wireless network setting method is introduced, the synchronizing wireless network setting methods are further introduced in details in accordance with FIG. 8 and FIG. 9.

FIG. 8 is a flowchart illustrating another synchronizing wireless network settings method 80 according to an exemplary embodiment of the invention. The synchronizing wireless network settings method 80 is the second synchronizing method of the invention, and starts at step S802. Auto channel selection functionality is activated at each one of wireless communication devices in the wireless communication network system (step S802). Each one of wireless communication devices in the wireless communication network system switches to all of the available channels, so as to broadcast the wireless network beacons thereof (step S804). Each one of wireless communication devices in the wireless communication network system scans all of the available channels, so as to search for any other wireless communication device whose wireless network setting is not yet updated (step S806). When a wireless communication device whose wireless network setting is not updated is discovered, the wireless action frame is transmitted, so as to configure the wireless communication device whose wireless network setting is not updated (step S808). The synchronizing wireless network settings method 80 is terminated after the step S808.

In the step S806, the approach of determining whether there is any wireless communication device whose wireless network setting is not updated is generally identical to the comparison approach illustrated in the step S701 in FIG. 7. That is, the determination module 203 compares a first sequence number stored thereon with a second sequence number of the received wireless network beacon.

The aforementioned step S804 to step S808 can be repeatedly executed, so as to continually synchronize the wireless network settings for meeting the requirements of practical operations. It is noted that, in the description of the synchronizing wireless network settings method 80, the wireless network beacon and the wireless action frame are just for purposes of illustration. In other embodiments of the invention, wireless network packets, wireless network signal or wireless network frames can also be used to broadcast the sequence number, or wireless network signal can be used for broadcasting the OUI 62 and the wireless network setting in the vendor-specific content 63, so as to realize the synchronizing wireless network settings method 80.

FIG. 9 is a flowchart illustrating a method for synchronizing wireless network settings according to an exemplary embodiment of the invention. A synchronizing wireless network settings method 90 is the third synchronizing method of the invention, and starts at step S902. Step S902 to step S906 are respectively similar to the step S802 to the step S806, so the technical content thereof are not repeated herein.

In the step S908, when a first wireless communication device (such as the wireless communication device 106) finds a sequence number of a second wireless network beacon is greater than the sequence number thereof, then request signal is transmitted from the first wireless communication device to a second wireless communication device (such as the wireless communication device 103) corresponding to the received wireless network beacon, so as to request the second wireless communication device transmit a wireless action frame for updating the wireless network setting thereof. In the aforementioned step S906, it is determined whether there is any wireless communication device whose wireless network setting is not updated, and the comparison procedure thereof is identical to that of the step S710 in FIG. 7. That is, the determination module 203 of the first wireless communication device compares the first sequence number with the second sequence number of the received wireless network beacon.

Next, in step S910, the first wireless communication device receives the wireless action frame 60 transmitted by the second wireless communication device, so as to update the wireless network setting thereof. The wireless action frame 60 includes newer or more updated wireless network setting in the vendor-specific content field 63. The synchronizing wireless network settings method 90 is terminated after the step S910.

The aforementioned step S904 to step S910 can be repeatedly executed, so as to continually synchronize the wireless network settings for meeting the requirements of practical operations. It is noted that, in the description of the synchronizing wireless network settings method 90, the wireless network beacon and the wireless action frame are just for purposes of illustration. In other embodiments of the invention, wireless network packets, wireless network signal or wireless network frames can also be used to broadcast the sequence number, or wireless network signal can be used for broadcasting the OUI 62 and the wireless network setting in the vendor-specific content 63, so as to realize the synchronizing wireless network settings method 80.

FIG. 10 is a flowchart illustrating a synchronizing wireless network settings method 1000 according to an exemplary embodiment of the invention. The embodiment of FIG. 10 basically combines two methods in FIG. 8 and FIG. 9 to a hybrid method for synchronizing wireless network settings. The synchronizing wireless network settings method 1000 starts from step S1002. The step S1002 to step S1006 are generally similar to the step S902 to the step S906, so the technical content thereof are not described herein. In the step S1008, a determination module 203 of each one of the wireless communication devices (such as the wireless communication device 101) in the wireless communication network system compares its own first sequence number with a second sequence number of one of the received wireless network beacons.

In step S1008, if its own first sequence number is greater than the second sequence number of the received wireless network beacon, then it represents that the wireless network setting of the wireless communication device 101 is newer, and step S1014 is executed after the step S1008. The received wireless network beacon corresponds to a wireless communication device at source end. In the step S1008, if its own first sequence number is less than the second sequence number of the received wireless network beacon, then it represents that the wireless network setting of the wireless communication device corresponding to the received wireless network beacon is newer, and step S1014 to step S1010 are executed after the step S1008. If its own first sequence number is identical to (or equal to) the second sequence number of the received wireless network beacon, then the step S1004 is executed after the step S1008.

In the step S1010, the wireless communication device 101 transmits request signal to the wireless communication device corresponding to the received wireless network beacon, so as to request the wireless communication device to transmit a second wireless action frame to update the wireless network setting thereof. In the step S1012, the wireless communication device 101 receives the second wireless action frame, and updates its own wireless network setting. In the step S1014, the wireless communication device 101 transmits a second wireless action frame, so as to configure the wireless communication device corresponding to the received wireless network beacon. The synchronizing wireless network settings method 1000 is terminated after the step S1012 or the step S1014. The step S1004 to the step S1014 can be repeatedly executed, so as to continually update the wireless network setting for meeting requirements of practical operations.

It is noted that, in the description of the synchronizing wireless network settings method 1000, the wireless network beacon and the wireless action frame are just for purposes of illustration. In other embodiments of the invention, wireless network packets, wireless network signal or wireless network frames can also be used to broadcast the sequence number, or wireless network signal can be used for broadcasting the OUI 62 and the wireless network setting in the vendor-specific content 63, so as to realize the synchronizing wireless network settings method 1000.

In summary, according to the embodiments of the invention, the invention proposes wireless communication systems and wireless communication devices thereof. The wireless network setting are transmitted just by wireless signal, wireless network beacons or wireless network frames. Also, through a distributed (or a diffusion) delivery approach, it can realize synchronizing the wireless network setting of each one of wireless communication devices in the wireless communication network system. Moreover, through actively requesting or actively transmitting wireless action frames, the overall transmission efficiency can be prevented from being lowered. In addition, through delivering the divided wireless network settings by one wireless action frame or a plurality of wireless action frames, it can also realize synchronizing large size or greater amount of wireless network settings.

It will be apparent to those skilled in the art that various modifications and variations of the exemplary embodiments can be made to the structure of the invention without departing from the scope or spirit of the invention. In view of the foregoing descriptions, it is intended that the present disclosure covers modifications and variations of the exemplary embodiments if they fall within the scope of the following claims and their equivalents.

What is claimed is:

1. A wireless communication system, adapted for synchronizing wireless network settings of at least a wireless communication device in the wireless communication system, the wireless communication system comprising:
the at least a wireless communication device, configured for synchronizing first wireless network setting thereof by merely at least wireless network signal, or synchronizing second wireless network setting of another wireless communication device by the at least wireless network signal, wherein,
the at least a wireless communication device determines whether the first wireless network setting is the latest by checking a sequence number in the at least wireless network signal from other wireless communication devices.

2. The wireless communication system according to claim 1, wherein the at least a wireless communication device activates auto channel selection functionality, so as to switch to each one of available channels in the wireless communication system.

3. The wireless communication system according to claim 2, wherein the at least a wireless network signal comprises a wireless network beacon, which comprises a sequence number, a feature value, and wireless network settings, wherein the wireless network settings is encrypted.

4. The wireless communication system according to claim 2, wherein the at least a wireless network signal comprises a wireless network beacon and a wireless action frame, wherein the wireless network beacon comprises a sequence number, and the wireless action frame comprises a feature value and a portion of wireless network settings, wherein the wireless network settings is encrypted.

5. The wireless communication system according to claim 3, wherein the at least a wireless communication device increments a first sequence number thereof after the first wireless network setting is updated, and encapsulates the first wireless network setting and the first sequence number in the wireless network beacon, and broadcast the wireless network beacon in each one of the available channels.

6. The wireless communication system according to claim 3, wherein the wireless network beacon is transmitted in a lowest transmission rate.

7. The wireless communication system according to claim 3, wherein the at least a wireless communication device determines whether there is new wireless network settings by scanning each one of the available channels within a fixed time interval, and checking at least a wireless network beacon received.

8. The wireless communication system according to claim 7, wherein, the at least a wireless communication device determines whether there is new wireless network settings by comparing a first sequence number stored thereon, and a second sequence number of the at least a received wireless network beacon, wherein there is new wireless network settings when the sequence number is greater than the first sequence number.

9. The wireless communication system according to claim 8, wherein, when the at least a wireless communication device discovers new wireless network settings, the at least a wireless communication device updates the first wireless network setting by using another wireless network settings in the at least received wireless network beacon.

10. The wireless communication system according to claim 4, wherein the at least a wireless communication device successively delivers a portion of the first wireless network setting by one wireless action frame or a plurality of wireless action frames, until all of the first wireless network setting is transmitted.

11. The wireless communication system according to claim 4, wherein the wireless action frame is not transmitted in a lowest transmission rate.

12. The wireless communication system according to claim 4, wherein the at least a wireless communication device switches to each one of the available channels, and listens to at least a wireless network beacon from other wireless communication devices in the wireless communication system.

13. The wireless communication system according to claim 12, wherein the at least a wireless communication device determines whether there is any wireless communication device whose wireless network settings is not updated by comparing a first sequence number stored thereon and a second sequence number in the at least a received wireless network beacon, wherein another wireless communication device is determined to be without updated wireless network settings when the second sequence number corresponding to the another wireless communication device is less than the first sequence number.

14. The wireless communication system according to claim 13, wherein the at least a wireless communication device transmits a first wireless action frame to update the another wireless communication device when the another wireless communication device is determined to be without updated wireless network settings.

15. The wireless communication system according to claim 8, wherein, when the at least a wireless communication device determines that the second sequence number is greater than the first sequence number, the at least a wireless communication device transmits request signal to the another wireless communication device corresponding to the second sequence number, so as to request the another wireless communication device to transmit a second wireless action frame to update the at least a wireless communication device.

16. A wireless communication device, adapted for synchronizing wireless network settings thereof, the wireless communication device comprising:
a wireless communication protocol stack module, configured for synchronizing first wireless network setting thereof by merely at least wireless network signal, or synchronizing second wireless network setting of another wireless communication device by the at least wireless network signal; and
a determination module, coupled to the wireless communication protocol stack module, configured for determining whether the first wireless network setting is the latest by checking a sequence number in the at least wireless network signal from other wireless communication devices.

17. The wireless communication device according to claim 16, wherein the wireless communication protocol stack module activates auto channel selection functionality, so as to switch to each one of available channels.

18. The wireless communication device according to claim 17, wherein the wireless communication device further comprising:
an encryption module, coupled to the wireless communication protocol stack module and the determination module, configured for encrypting wireless network settings, wherein the at least wireless network signal comprises a wireless network beacon, which comprises a sequence number, a feature value and the encrypted wireless network settings.

19. The wireless communication device according to claim 17, wherein the wireless communication device further comprising:
an encryption module, coupled to the wireless communication protocol stack module and the determination module, configured for encrypting wireless network settings, wherein the at least wireless network signal comprises a wireless network beacon and a wireless action frame, wherein the wireless network beacon comprises a sequence number, and the wireless action frame comprises a feature value and a portion of the encrypted wireless network settings.

20. The wireless communication device according to claim 18, wherein the wireless communication protocol stack module increments a first sequence number after the first sequence number thereof is updated, encapsulates the first wireless network setting and the first sequence number into the wireless network beacon, and broadcasts the wireless network beacon in each one of the available channels.

21. The wireless communication device according to claim 18, wherein the wireless communication protocol stack module transmits the wireless network beacon in a lowest transmission rate.

22. The wireless communication device according to claim 18, wherein the wireless communication protocol stack module scans each one of the available channels within a fixed time interval, and the determination module determines whether there is new wireless network settings by checking at least a wireless network beacon received by the wireless communication protocol stack module.

23. The wireless communication device according to claim 22, wherein the determination module determines whether there is new wireless network settings by comparing a first sequence number stored thereon, and a second sequence number of the at least a received wireless network beacon, wherein the determination module determines that there is new wireless network settings when the sequence number is greater than the first sequence number.

24. The wireless communication device according to claim 23, wherein, when the determination module discovers new wireless network settings, the wireless communication protocol stack module updates the first wireless network setting by using another wireless network settings in the at least received wireless network beacon.

25. The wireless communication device according to claim 19, wherein the wireless communication protocol stack module successively delivers a portion of the first wireless network setting by one wireless action frame or a plurality of wireless action frames, until all of the first wireless network setting is transmitted.

26. The wireless communication device according to claim 19, wherein the wireless communication protocol stack module does not transmit the wireless action frame in a lowest transmission rate.

27. The wireless communication device according to claim 19, wherein the wireless communication protocol stack module switches to each one of the available channels, and listens to at least a wireless network beacon from other wireless communication devices in the wireless communication system.

28. The wireless communication device according to claim 27, wherein the determination module determines whether there is any wireless communication device whose wireless network settings is not updated by comparing a first sequence number stored thereon and a second sequence number in the at least a received wireless network beacon, wherein another wireless communication device is determined to be without updated wireless network settings when the second sequence number corresponding to the another wireless communication device is less than the first sequence number.

29. The wireless communication device according to claim 27, wherein the wireless communication protocol stack module transmits a first wireless action frame to update another wireless communication device when the determination module determines that the wireless network settings of the another wireless communication device is not updated.

30. The wireless communication device according to claim 28, wherein, when the determination module determines that the second sequence number is greater than the first sequence number, the wireless communication protocol stack module transmits request signal to the another wireless communication device corresponding to the second sequence number, so as to request the another wireless communication device to transmit a second wireless action frame to update the first wireless setting.
